(19) United States
(12) Patent Application Publication
(10) Pub. No.: US 2023/0262564 A1
(43) Pub. Date: Aug. 17, 2023

(54) RADIO LINK FAILURE IN SIDELINK RELAY

(71) Applicant: QUALCOMM Incorporated, San Diego, CA (US)

(72) Inventors: Peng CHENG, Beijing (CN); Karthika PALADUGU, San Diego, CA (US); Hong CHENG, Basking Ridge, NJ (US); Gavin Bernard HORN, La Jolla, CA (US)

(21) Appl. No.: 18/003,890

(22) PCT Filed: Aug. 7, 2020
(86) PCT No.: PCT/CN2020/107675

§ 371 Date: Dec. 29, 2022

(51) Int. Cl. H04W 36/30; H04W 36/00; H04W 40/24

(52) U.S. Cl. CPC H04W 36/305; H04W 36/03; H04W 40/246; H04W 88/04

(57) ABSTRACT

Certain aspects of the present disclosure provide techniques for relay reselection triggering in sidelink relay systems. An example method for relay reselection triggering by a relay user equipment (UE) generally includes detecting a radio link failure (RLF) on at least one of a first link between the relay UE and a serving network entity or a second link between the relay UE and a remote UE and taking one or more actions, in response to the detection, to trigger relay reselection by the remote UE.

### FIELD OF THE DISCLOSURE

Aspects of the present disclosure relate to wireless communications, and more particularly, to techniques for triggering relay and/or cell reselection in sidelink relay systems.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication by a relay UE. The method generally includes detecting a radio link failure (RLF) on at least one of a first link between the relay UE and a serving network entity or a second link between the relay UE and a remote UE and taking one or more actions, in response to the detection, to trigger relay reselection by the remote UE.

Certain aspects, provide an apparatus by a relay UE. The apparatus generally includes a memory and a at least one processor configured to detect a radio link failure (RLF) on at least one of a first link between the relay UE and a serving network entity or a second link between the relay UE and a remote UE, and taking one or more actions, in response to the detection, to trigger relay reselection by the remote UE.

Certain aspects, provide an apparatus by a relay UE. The apparatus generally includes means for detecting a radio link failure (RLF) on at least one of a first link between the relay UE and a serving network entity or a second link between the relay UE and a remote UE, and means for taking one or more actions, in response to the detection, to trigger relay reselection by the remote UE.

Certain aspects provide a method for wireless communication by a remote UE. The method generally includes detecting a trigger event indicative of a radio link failure (RLF) on at least one of a first link between a relay UE and a serving network entity or a second link between the remote UE and the relay UE and performing relay reselection, in response to the detection, based on link quality measurements on one or more links between the remote UE and one or more relay UEs and other one or more other criteria.

Certain aspects, provide an apparatus by a remote UE. The apparatus generally includes a memory and a at least one processor configured to detect a trigger event indicative of a radio link failure (RLF) on at least one of a first link between a relay UE and a serving network entity or a second link between the remote UE and the relay UE, and perform relay reselection, in response to the detection, based on link quality measurements on one or more links between the remote UE and one or more relay UEs and other one or more other criteria.

Certain aspects, provide an apparatus by a remote UE. The apparatus generally includes means for detecting a trigger event indicative of a radio link failure (RLF) on at least one of a first link between a relay UE and a serving network entity or a second link between the remote UE and the relay UE, and means for performing relay reselection, in response to the detection, based on link quality measurements on one or more links between the remote UE and one or more relay UEs and other one or more other criteria.

Certain aspects provide a method for wireless communication by a network entity. The method generally includes receiving, via a first link between a relay user equipment (UE) and the network entity, a report indicating a radio link failure (RLF) on a second link between the relay UE and a remote UE and taking one or more actions, in response to the report, to trigger relay reselection by the remote UE.

Certain aspects, provide an apparatus by a network entity. The apparatus generally includes a memory and a at least one processor configured to receive, via a first link between a relay user equipment (UE) and the network entity, a report indicating a radio link failure (RLF) on a second link between the relay UE and a remote UE, and take one or more actions, in response to the report, to trigger relay reselection by the remote UE.

Certain aspects, provide an apparatus by a network entity. The apparatus generally includes means for receiving, via a first link between a relay user equipment (UE) and the network entity, a report indicating a radio link failure (RLF) on a second link between the relay UE and a remote UE, and means for taking one or more actions, in response to the report, to trigger relay reselection by the remote UE.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a high level path diagram illustrating example connection paths of a remote user equipment (UE), in accordance with certain aspects of the present disclosure.

FIG. 6 is an example block diagram illustrating a control plane protocol stack on L3, when there is no direct connection path between the remote UE and the network node, in accordance with certain aspects of the present disclosure.

FIG. 7 is an example block diagram illustrating a control plane protocol stack on L2, when there is direct connection path between the remote UE and the network node, in accordance with certain aspects of the present disclosure.

FIG. 8 illustrates example layer 3 (L3) relay procedures, in accordance with certain aspects of the present disclosure.

FIG. 9 illustrates example layer 2 (L2) relay procedures, in accordance with certain aspects of the present disclosure.

FIGS. 10A and 10B illustrate example relay discovery procedures.

FIG. 11 illustrates an example communications environment in which a relay UE serves one or more remote UEs.

FIG. 12 illustrates example operations for wireless communications by a relay UE, in accordance with certain aspects of the present disclosure.

FIG. 13 illustrates example operations for wireless communications by a remote UE, in accordance with certain aspects of the present disclosure.

FIG. 14 illustrates example operations for wireless communications by a network entity, in accordance with certain aspects of the present disclosure.

FIG. 15 illustrates a communications device that may include various components configured to perform the operations illustrated in FIG. 12, in accordance with certain aspects of the present disclosure.

FIG. 16 illustrates a communications device that may include various components configured to perform the operations illustrated in FIG. 13, in accordance with certain aspects of the present disclosure.

FIG. 17 illustrates a communications device that may include various components configured to perform the operations illustrated in FIG. 14, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for triggering relay and/or cell reselection in sidelink relay systems.

The connection between the relay and the network entity, may be called a Uu connection or via a Uu path. The connection between the remote UE and the relay (e.g., another UE or a “relay UE”), may be called a PC5 connection or via a PC5 path. The PC5 connection is a device-to-device connection that may take advantage of the comparative proximity between the remote UE and the relay UE (e.g., when the remote UE is closer to the relay UE than to the closest base station). The relay UE may connect to an infrastructure node (e.g., gNB) via a Uu connection and relay the Uu connection to the remote UE through the PC5 connection.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. Cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (SGTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). Cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

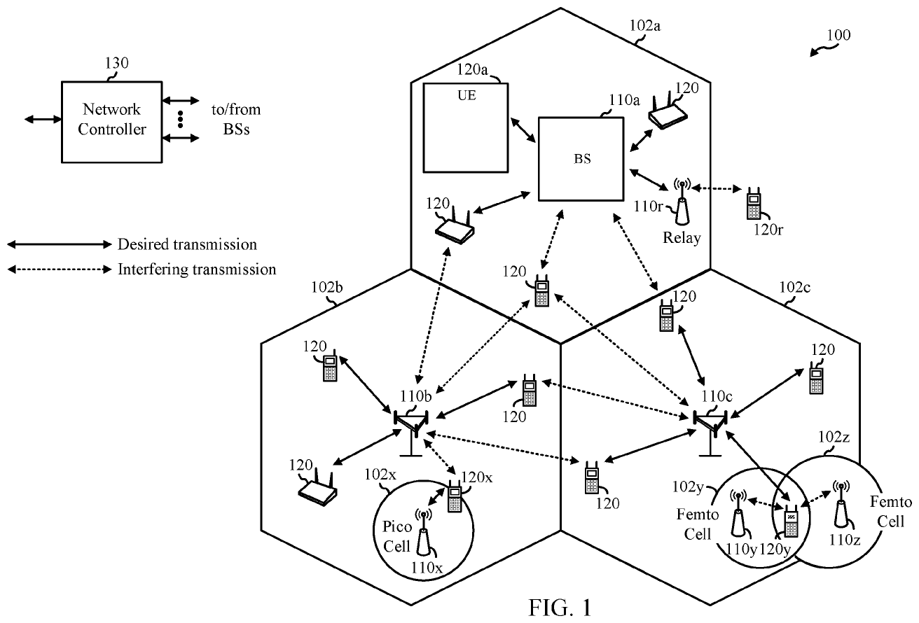

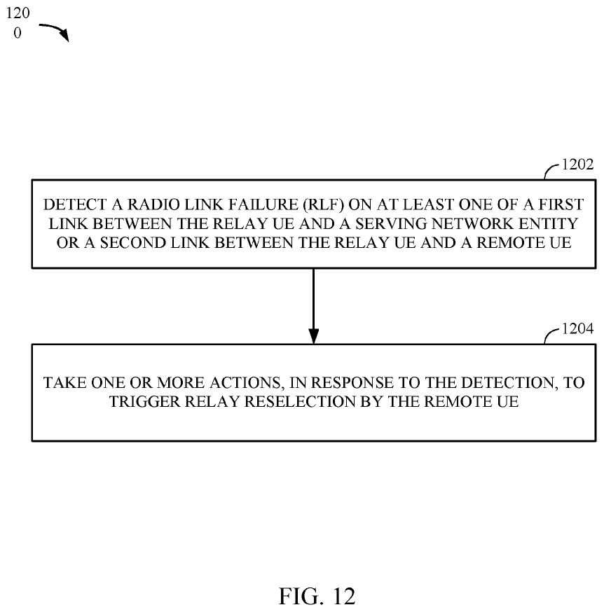

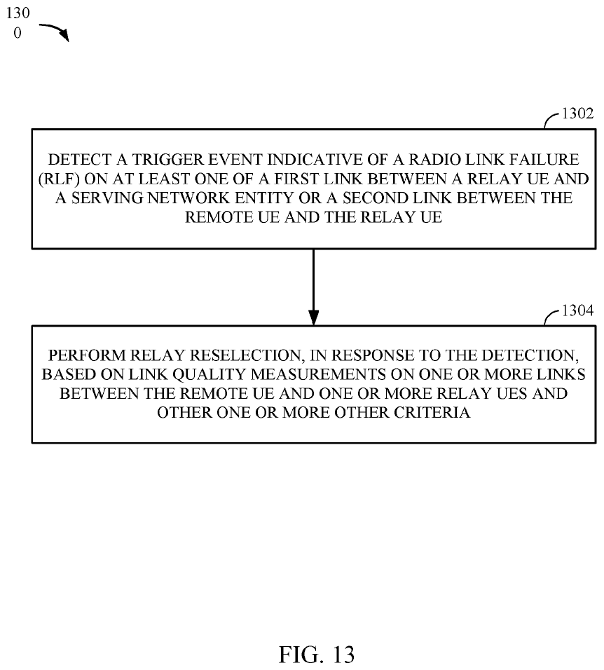

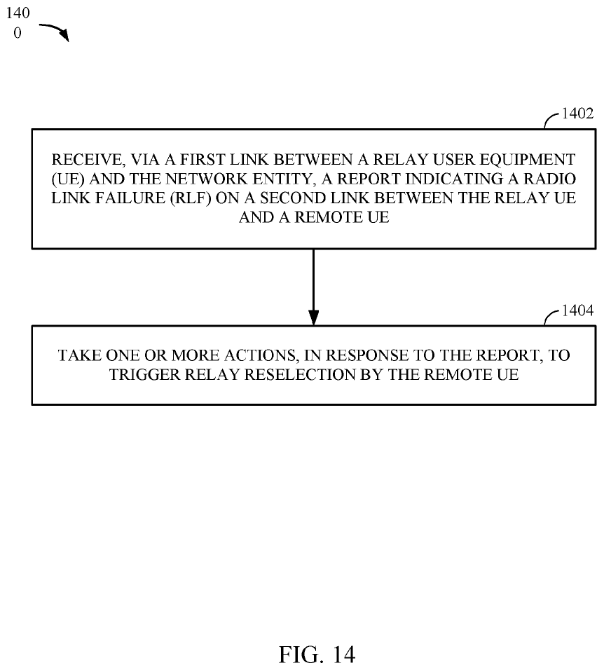

FIG. 1 illustrates an example wireless communication network 100 in which aspects of the present disclosure may be performed. For example, UEs 120a may be configured to perform operations 1200 and/or 1300 described below with reference to FIGS. 12 and 13 for triggering relay and/or cell reselection, while a base station 110a may be configured to perform operations 1400 of FIG. 14.

As illustrated in FIG. 1, the wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

Wireless communication network 100 may also include relay UEs (e.g., relay UE 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

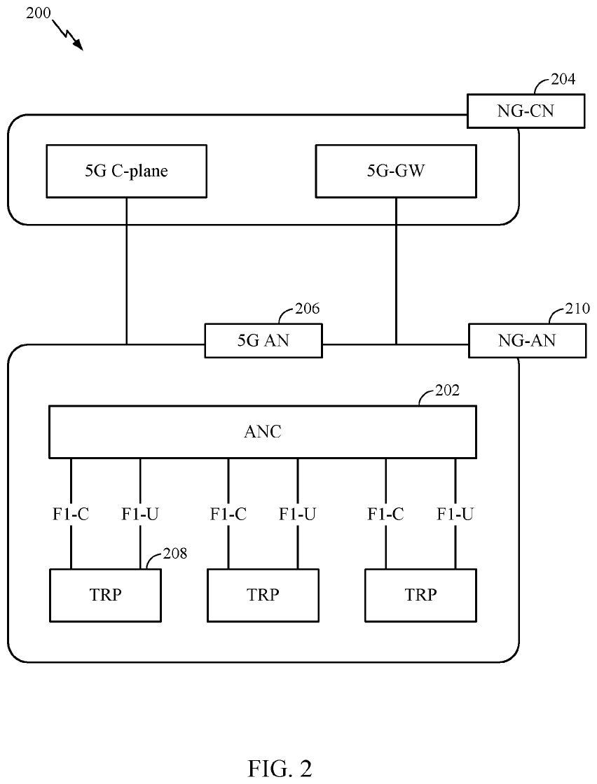

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

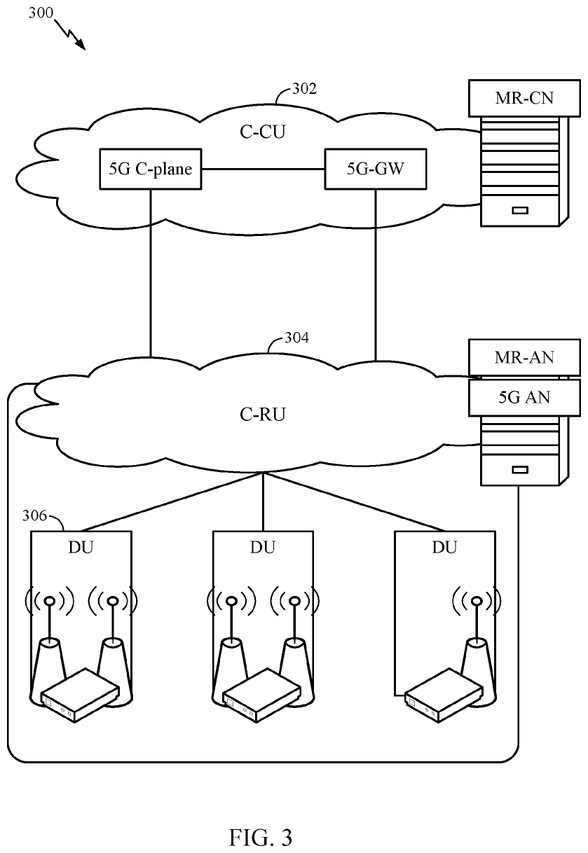

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

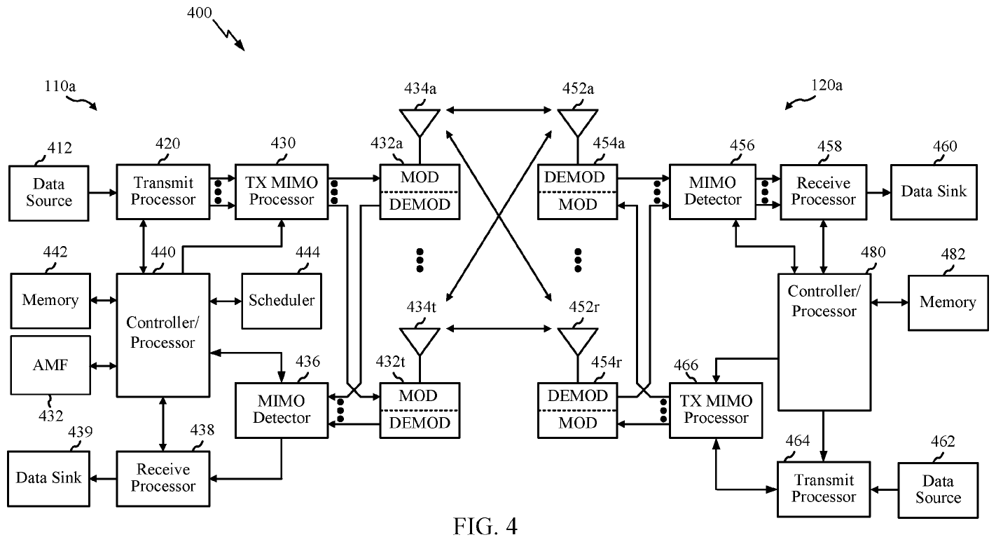

FIG. 4 illustrates example components of BS 110a and UE 120a (as depicted in FIG. 1), which may be used to implement aspects of the present disclosure. For example, antennas 452, processors 466, 458, 464, and/or controller/processor 480 of the UE 120a may be used to perform the various techniques and methods described herein with reference to FIGS. 12 and 13, while antennas 434, processors 420, 430, 438, and/or controller/processor 440 of the BS 110a may be used to perform the various techniques and methods described herein with reference to FIG. 14.

At the BS 110a, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120a, the antennas 452a through 452r may receive the downlink signals from the base station 110a and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the uplink, at UE 120a, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110a. At the BS 110a, the uplink signals from the UE 120a may be received by the antennas 434, processed by the modulators 432, detected by a MIMO detector 436 if applicable, and further processed by a receive processor 438 to obtain decoded data and control information sent by the UE 120a. The receive processor 438 may provide the decoded data to a data sink 439 and the decoded control information to the controller/processor 440.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

### Example UE to NW Relay

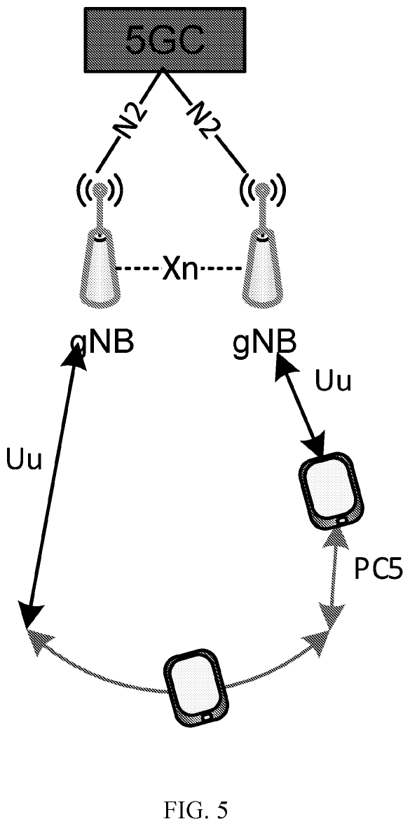

Aspects of the present disclosure involves a remote UE, a relay UE, and a network, as shown in FIG. 5, which is a high level path diagram illustrating example connection paths: a Uu path (cellular link) between a relay UE and the network gNB, a PC5 path (D2D link) between the remote UE and the relay UE. The remote UE and the relay UE may be in radio resource control (RRC) connected mode.

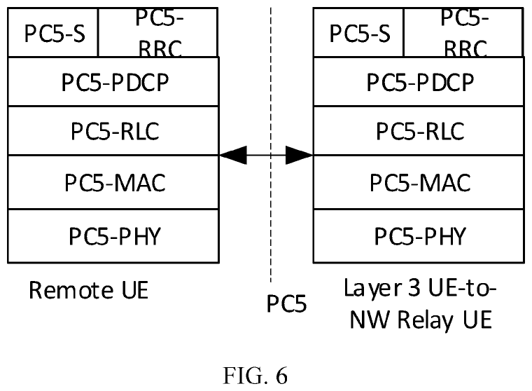

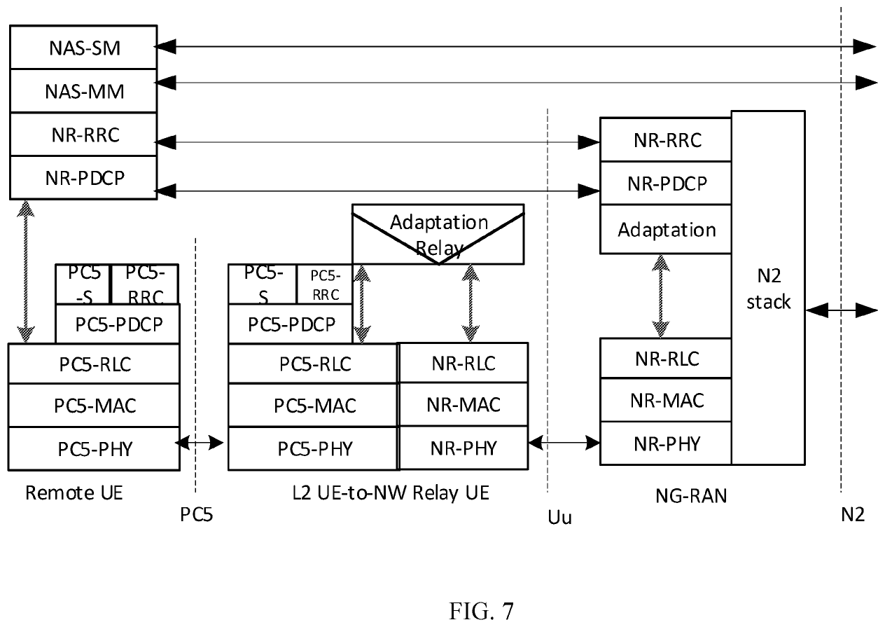

As shown in FIGS. 6 and FIG. 7, remote UE may generally connect to a relay UE via a layer 3 (L3) connection with no Uu connection with (and no visibility to) the network or via a layer 2 (L2) connection where the UE supports Uu access stratum (AS) and non-AS connections (NAS) with the network.

FIG. 6 is an example block diagram illustrating a control plane protocol stack on L3, when there is no direct connection path (Uu connection) between the remote UE and the network node. In this situation, the remote UE does not have a Uu connection with a network and is connected to the relay UE via PC5 connection only (e.g., Layer 3 UE-to-NW). The PC5 unicast link setup may, in some implementations, be needed for the relay UE to serve the remote UE. The remote UE may not have a Uu application server (AS) connection with a radio access network (RAN) over the relay path. In other cases, the remote UE may not have direct none access stratum (NAS) connection with a 5G core network (5GC). The relay UE may report to the 5GC about the remote UE's presence. Alternatively and optionally, the remote UE may be visible to the 5GC via a non-3GPP interworking function (N3IWF).

FIG. 7 is an example block diagram illustrating a control plane protocol stack on L2, when there is direct connection path between the remote UE and the network node. This control plane protocol stack refers to an L2 relay option based on NR-V2X connectivity. Both PC5 control plane (C-plane) and the NR Uu C-plane are on the remote UE, similar to what is illustrated in FIG. 6. The PC5 C-plane may set up the unicast link before relaying. The remote UE may support the NR Uu AS and NAS connections above the PC5 radio link control (RLC). The NG-RAN may control the remote UE's PC5 link via NR radio resource control (RRC). In some embodiments, an adaptation layer may be needed to support multiplexing multiple UEs traffic on the relay UE's Uu connections.

Certain systems, such as NR, may support standalone (SA) capability for sidelink-based UE-to-network and UE-to-UE relay communications, for example, utilizing layer-3 (L3) and layer-2 (L2) relays, as noted above.

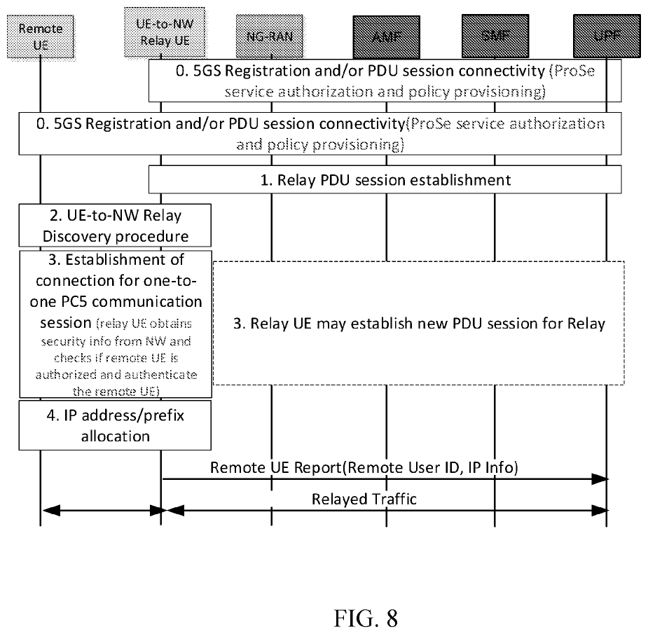

Particular relay procedures may depend on whether a relay is a L3 or L2 relay. FIG. 8 illustrates an example dedicated PDU session for an L3 relay. In the illustrated scenario, a remote UE establishes PC5-S unicast link setup and obtains an IP address. The PC5 unicast link AS configuration is managed using PC5-RRC. The relay UE and remote UE coordinate on the AS configuration. The relay UE may consider information from RAN to configure PC5 link. Authentication/authorization of the remote UE access to relaying may be done during PC5 link establishment. In the illustrated example, the relay UE performs L3 relaying.

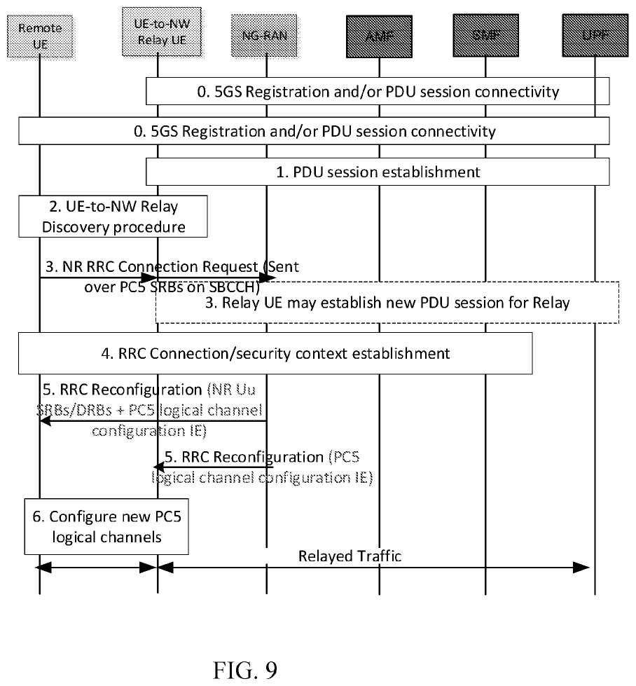

FIG. 9 illustrates an example dedicated PDU session for an L2 relay. In the illustrated scenario, there is no PC5 unicast link setup prior to relaying. The remote UE sends the NR RRC messages on PC5 signaling radio bearers (SRBs) over a sidelink broadcast control channel (SBCCH). The RAN can indicate the PC5 AS configuration to remote UE and relay UE independently via NR RRC messages. Changes may be made to NR V2X PC5 stack operation to support radio bearer handling in NR RRC/PDCP but support corresponding logical channels in PC5 link. In L2 relaying, PC5 RLC may need to support interacting with NR PDCP directly.

There are various issues to be addressed with sidelink relay DRX scenarios. One issue relates to support of a remote UE sidelink DRX for relay discovery. One assumption for relay discover in some cases is that the Relay UE is in CONNECTED mode only, rather than IDLE/INACTIVE. A remote UE, may be in a CONNECTED, IDLE/INACTIVE or out of coverage (OOC) modes.

Mechanisms may also be provided for relay selection and reselection. Relay selection generally refers the procedure whereby a remote UE has not connected to any relay node, discovers relay nodes whose sidelink discovery reference signal receive power (SD-RSRP) is above a threshold level (possibly by some amount) and, from among them, selects the relay node with best SD-RSRP. Relay re-selection generally refers the procedure whereby the remote UE has connected to one relay node (e.g., already performed relay selection), when SD-RSRP of the current relay node falls below a threshold level (possibly by some amount), the remote UE discovers relay nodes whose SD-RSRP is above a threshold level (possibly by some amount) and, among them, (re-) selects the relay node with the best SD-RSRP.

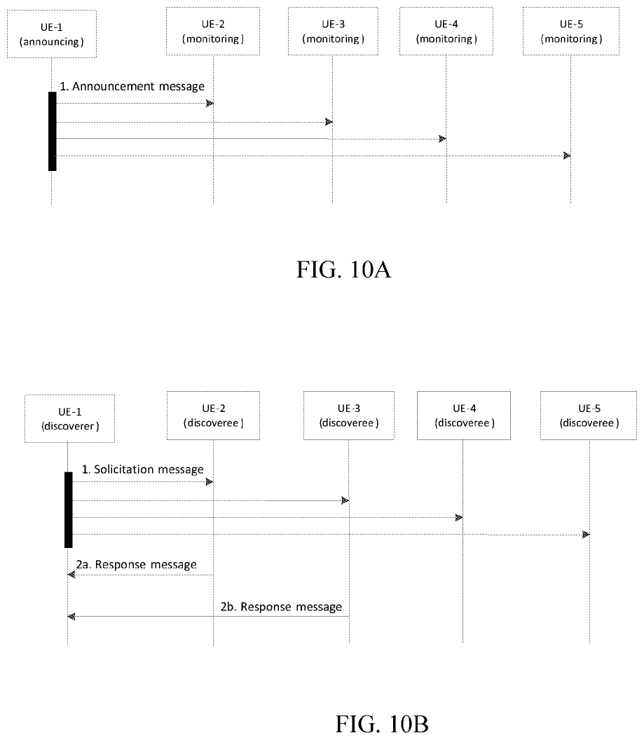

Discovery for both relay selection and reselection may be supported. Different type of discovery models may be supported. For example, a first model (referred to as Model A discovery) is shown in FIG. 10A. In this case, a UE sends discovery messages (e.g., an announcement) while other UEs monitor for such discovery messages.

In some cases, relay service codes may identify the connectivity service that a relay UE (e.g., a ProSe Relay UE) provides. The relay service codes may be, for example, pre-configured or provisioned by a policy control function (PCF) to the UEs. In some cases, security information for discovery messages may be provisioned during key management process. Remote UEs may discover the relay UE by monitoring only corresponding relay service code(s).

According to a second model (referred to as Model B discovery) shown in FIG. 10B, a UE (discoverer) sends a solicitation message and waits for responses from monitoring UEs (discoverees). Such discovery messages may be sent on a PC5 communication channel (e.g., and not on separate discovery channel). Discovery messages may be carried within the same layer-2 frames as those used for other direct communication including, for example, the Destination Layer-2 ID that can be set to a unicast, groupcast or broadcast identifier, the Source Layer-2 ID that is always set to a unicast identifier of the transmitter, and the frame type indicates that it is a ProSe Direct Discovery message.

As noted above, for relay selection, the remote UE has not connected to any relay node (i.e. PC5 unicast link is not established between remote UE and relay node). In this case, it may be desirable to design DRX modes to reduce remote UE power consumption on monitoring relay discovery messages for relay selection.

As noted above, for relay reselection, the remote UE has connected to at least one relay node (e.g., with a PC5 unicast established between the emote UE and relay node). For relay reselection, it may be desirable to design a DRX configuration that helps reduce remote UE power consumption while monitoring for relay discovery messages for relay reselection and PC5 data transmission.

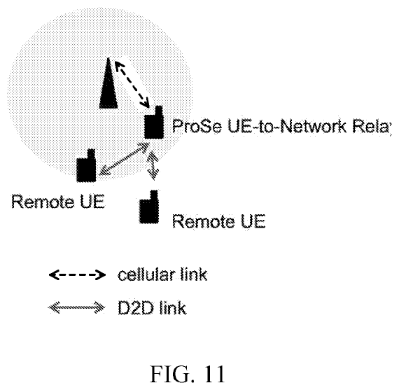

FIG. 11 illustrates an example environment in which remote UEs are served by a network entity through a UE-to-network relay (e.g., a relay UE). To communicate through a relay UE, a remote UE, which has not connected to a relay node, may discover relay nodes and select one or more of the relay nodes as the remote UE's relay. The remote UE may, for example, discover all relay nodes with a sidelink discovery reference signal received power (SD-RSRP) above a first threshold value (e.g., more than minHyst above q-Rx-LevMin). The remote UE may also reselect a relay when the remote UE is already connected with a relay node. To do so, the remote UE can determine that the sidelink RSRP (SL-RSRP) is below a second threshold value (e.g., more than minHyst below q-Rx-LevMin), and based on the determination, discover relay nodes having an SD-RSRP above the first threshold value.

### Example RLF in Sidelink Relay Systems

Aspects of the present disclosure relate to wireless communications, and more particularly, to techniques for triggering relay and/or cell reselection in sidelink relay systems (e.g., new radio (NR) sidelink relay systems) based on radio link failure (RLF). In some cases, relay and/or cell reselection may be triggered in response to a radio link failure in cellular links (Uu) and/or sidelink (PC5).

As will be described herein, upon detecting an RLF on Uu and/or PC5, a relay UE may take action to trigger a remote UE to perform relay re-selection (because the RLF may effectively render the relay UE unsuitable).

In general, a (remote or relay) UE may declare a PC5 RLF based on a number of conditions. For example, RLF may occur when a maximum number of retransmissions of radio link control (RLC) is reached. Another condition may be when reconfiguration fails (e.g., T400 expiry). As another example, RLF may occur when a maximum number of consecutive hybrid automatic repeat request (HARQ) discontinuous transmissions (DTX) for one destination is reached. Further, RLF may occur when a PC5 internet protocol (IP) check fails. It should be noted that each of the above mentioned conditions may be transmission (TX) detected RLF or reception (RX) detected RLF.

Upon declaration of PC5 RLF, the access stratum (AS) layer of the UE may send a PC5 RLF indication including a PC5 link identifier to an upper layer (e.g., a vehicle-to-everything (V2X) layer) to indicate the PC5 unicast link whose RLF declaration was made, and a PC5 radio resource control (RRC) connection was released. If the UE is in a connected mode, the UE may report, to a network entity, whether RLF and/or reconfiguration failure occurred.

In some cases of RLF, joint cell (re)selection and/or relay (re)selection may be accomplished either before or after a remote UE is connected to the relay UE. In the case of before the remote UE is connected to the relay UE, the remote UE may first perform cell (re)selection (e.g., attempt to search and camp in one “suitable” cell). If the cell (re)selection procedure fails (e.g., the remote UE cannot find any “suitable” cell), the remote UE regards it as out-of-coverage, and starts a relay selection procedure.

In the case of after the remote UE is connected to the relay UE, multiple options may exist. For example, if there is at least one “suitable” relay available, the remote UE may only perform relay (re)selection (i.e., not perform cell (re)selection). In other cases, the remote UE may regard relay UEs as inter radio access technology (RAT) cells, and thus perform joint cell reselection and relay reselection. In this case, the remote UE performs a relay reselection procedure to ensure that the connected relay is “suitable” and has the highest sidelink reference signal received power (SL-RSRP). Furthermore, the remote UE may regard the relay with which it is connected as its serving cell, and the remote UE may calculate a cell ranking criterion Rₛ, based on SL-RSRP and/or sidelink reference signal received quality (SL-RSRQ) and a hysteresis parameter Q_{Hyst} broadcast by relay. Additionally, the remote UE may treat all Uu cells as neighbor cells, and the remote UE may perform a cell reselection procedure and calculate cell ranking criterion Rₙ based on their RSRP/RSRQ and Q_{offset} broadcast by these cells. In another case, the remote UE may rank a cell according to the best relay which can be used to connect to that cell and the remote UE may consider relay downlink (DL) signal quality as a proxy for that cell.

In general, there are various conditions to trigger relay reselection. As one example, the current relay UE is not “suitable” any more (e.g., SL-RSRP is not above a q-RxLevMin by minHyst). As another example, the remote UE receives a layer-2 (L2) link release message (e.g., upper layer message) from the relay UE. As still another example, the quality of service (QoS) requirement of the traffic can't be satisfied by the Relay.

Aspects of the present disclosure address yet another condition to trigger relay reselection: a radio link failure (RLF). RLF in Uu and/or PC5 can also be a condition in which relay reselection is triggered (e.g., for L2 and/or layer 3 (L3) relays).

Accordingly, certain aspects of the present disclosure provide techniques for triggering relay reselection in response to RLF. As will be described in more detail, based on the link in which the RLF occurs, cell reselection may be triggered in a variety of ways.

FIG. 12 illustrates example operations 1200 for wireless communications by a relay UE. Operations 1200 may be performed, for example, by a UE 120a of FIG. 1 or FIG. 4 to trigger relay and/or cell reselection based on a Uu or PC5 RLF, in accordance with aspects of the present disclosure.

Operations 1200 begin, at 1202, by detecting a radio link failure (RLF) on at least one of a first link between the relay UE and a serving network entity or a second link between the relay UE and a remote UE. At 1204, the relay UE takes one or more actions, in response to the detection, to trigger relay reselection by the remote UE.

FIG. 13 illustrates example operations 1300 for wireless communications by a remote UE. For example, operations 1300 may be performed by a UE 120a of FIG. 1 or FIG. 4 to trigger relay and/or cell reselection based on an RLF, in accordance with aspects of the present disclosure.

Operations 1300 begin, at 1302, by detecting a trigger event indicative of a radio link failure (RLF) on at least one of a first link between a relay UE and a serving network entity or a second link between the remote UE and the relay UE. At 1304, the remote UE performs relay reselection, in response to the detection, based on link quality measurements on one or more links between the remote UE and one or more relay UEs and other one or more other criteria.

FIG. 14 illustrates example operations 1400 for wireless communications by a network entity. For example, operations 1400 may be performed by a BS 110 of FIG. 1 or FIG. 4 to reconfigure a remote UE after an RLF reported by a relay UE, in accordance with aspects of the present disclosure.

Operations 1400 begin, at 1402, by receiving, via a first link between a relay user equipment (UE) and the network entity, a report indicating a radio link failure (RLF) on a second link between the relay UE and a remote UE. At 1404, the network entity taking one or more actions, in response to the report, to trigger relay reselection by the remote UE.

In some cases, the RLF may occur in Uu in a link between the relay UE and the network entity, when the relay UE is in an RRC connected state.

Upon Uu RLF being declared, if the PC5 link with the remote UE is available, the relay UE may send a L2 link release message to the remote UE, and the UE may then perform a re-establishment procedure (e.g., a legacy Uu RRC re-establishment procedure).

Upon reception of the L2 link release message from the relay UE, the remote UE may release the PC5 RRC with the relay UE and perform relay reselection. If the relay reselection fail (e.g., no suitable relay is available), the remote UE may trigger cell selection. If the cell selection fails, the remote UE may declare an out-of-coverage state.

Alternatively, upon Uu RLF being declared, if the PC5 link with the remote UE is unavailable (e.g., PC5 RLF detected at the same time), the relay UE may cease transmission of a relay discovery message. Thus, the remote UE will not be able to detect discovery message from the relay UE, and will not regard the relay UE as a suitable relay anymore, triggering relay reselection. However, if relay reselection fails (e.g., no suitable relay available), the remote UE may trigger cell selection. If cell selection fails, the remote UE may declare an out-of-coverage state.

In some cases, the RLF may occur in PC5 in a link between the relay UE and the remote UE. In this case, the relay UE may originally have been in a RRC connected state or a RRC idle/inactive state.

Upon PC5 RLF being declared in relay, if the Uu link is available (e.g., no Uu RLF) and the relay UE is in a RRC connected state, the relay UE may send a PC5 RLF report to the network entity (e.g., via sidelinkUEInformation message). The PC5 RLF report may include an RLF cause, a remote UE ID, and/or available SL-RSRP measurements. In this case, the network entity may trigger a RRC state management procedure for the remote UE. For example, the network entity may remove the remote UE context and/or send the remote UE to an idle state.

Upon PC5 RLF being declared in relay, if the Uu link is available and the relay UE is in an idle/inactive state, the relay UE may requests to enter a connected state (e.g., by sending RRCSetupRequest or RRCResumeRequest to the network entity). Once the relay UE enters the connected state with the network entity, the relay UE may send the PC5 RLF report to the network entity as described above.

Alternatively, upon PC5 RLF being declared in relay, if Uu link is not available (e.g., Uu RLF detected at the same time), the relay UE may cease transmission of a relay discovery message. Thus, the remote UE may no longer be able to detect the discovery message from relay, and will regard the relay as no longer being a suitable relay, triggering relay reselection. However, if relay reselection fails (e.g., no suitable relay available), the remote UE may trigger cell selection. If cell selection fails, the remote UE may declare an out-of-coverage state.

In some cases, a remote UE that does not have a direct connection with the gNB may detect a PC5 RLF. Upon PC5 RLF being declared in the remote UE, the remote UE may then trigger relay reselection. However, if relay reselection fails (e.g., no suitable relay available), the remote UE may trigger cell selection. If cell selection fails, the remote UE may declare an out-of-coverage state.

In current implementations, the remote UE may perform relay (re)selection by only considering PC5 link quality (e.g., with sidelink discovery RSRP (SD-RSRP)). In other words, discovery of relay UEs may be based on SD-RSRP being above a threshold q-RxLevMin by minHyst. The relay node with best SD-RSRP may be selected as the remote UE's relay.

Aspects of the present disclosure, however, provide techniques where higher layers may be involved alternative to or in addition to the SD-RSRP. For example, relay discovery message contents may indicate relay UE candidates to the access stratum (AS) layer, and AS based on PC5 radio/measurements to select them. As another example, AS layer may be provided an ordered list of relay candidates, based on PC5 radio condition. In this case, the upper layer may select the relay based on discovery message contents.

In this manner, higher layer criteria for relay selection may be based on discovery message contents. An example of such higher layer criteria may be a QoS of the discovery message or special contents of discovery message. Because higher layers may exclude some relay UEs based on relay discovery message contents, the selected relay may not be the one with best PC5 link quality.

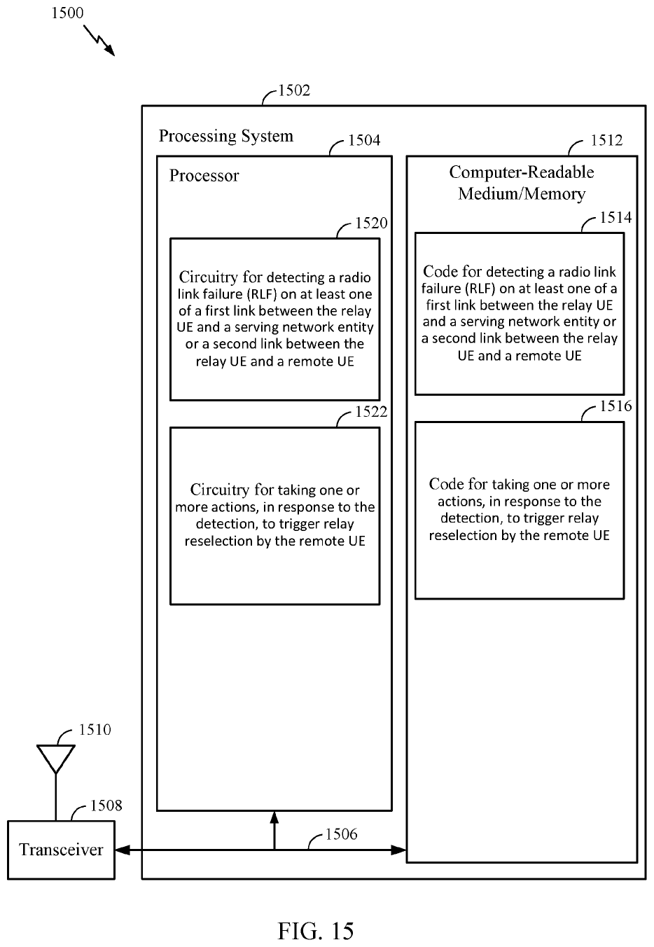

FIG. 15 illustrates a communications device 1500 that may include various components (e.g., corresponding to means-plus-function components) configured to perform operations for the techniques disclosed herein, such as the operations illustrated in FIG. 12. The communications device 1500 includes a processing system 1502 coupled to a transceiver 1508. The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes a processor 1504 coupled to a computer-readable medium/memory 1512 via a bus 1506. In certain aspects, the computer-readable medium/memory 1512 is configured to store instructions (e.g., computer-executable code) that when executed by the processor 1504, cause the processor 1504 to perform the operations illustrated in FIG. 12. In certain aspects, computer-readable medium/memory 1512 stores code 1514 for detecting a radio link failure (RLF) on at least one of a first link between the relay UE and a serving network entity or a second link between the relay UE and a remote UE and code 1516 for taking one or more actions, in response to the detection, to trigger relay reselection by the remote UE. In certain aspects, the processor 1504 has circuitry configured to implement the code stored in the computer-readable medium/memory 1512. The processor 1504 includes circuitry 1520 for detecting a radio link failure (RLF) on at least one of a first link between the relay UE and a serving network entity or a second link between the relay UE and a remote UE and circuitry 1522 for taking one or more actions, in response to the detection, to trigger relay reselection by the remote UE.

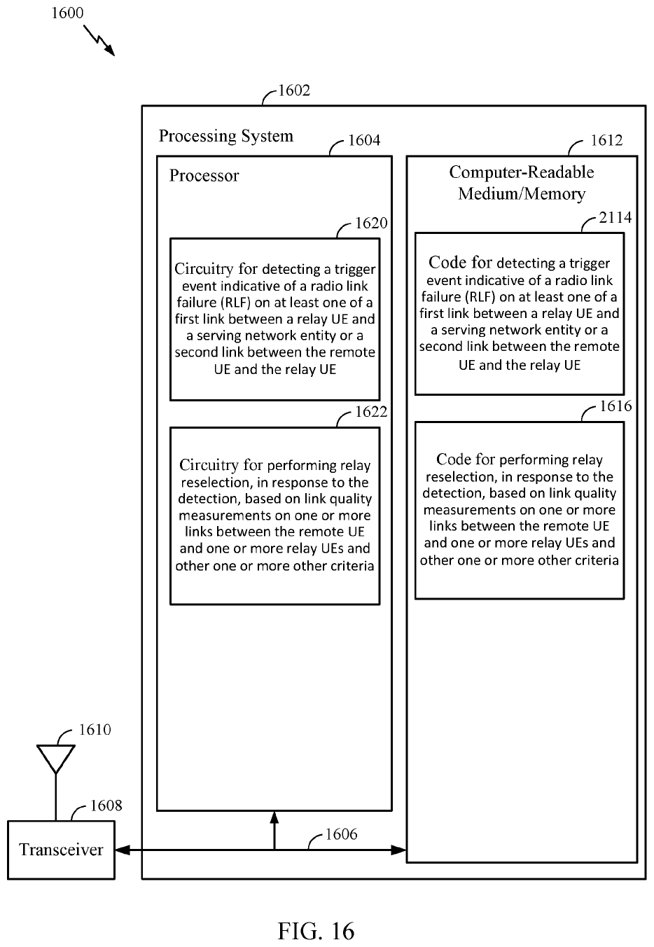

FIG. 16 illustrates a communications device 1600 that may include various components (e.g., corresponding to means-plus-function components) configured to perform operations for the techniques disclosed herein, such as the operations illustrated in FIG. 13. The communications device 1600 includes a processing system 1602 coupled to a transceiver 1608. The transceiver 1608 is configured to transmit and receive signals for the communications device 1600 via an antenna 1610, such as the various signals as described herein. The processing system 1602 may be configured to perform processing functions for the communications device 1600, including processing signals received and/or to be transmitted by the communications device 1600.

The processing system 1602 includes a processor 1604 coupled to a computer-readable medium/memory 1612 via a bus 1606. In certain aspects, the computer-readable medium/memory 1612 is configured to store instructions (e.g., computer-executable code) that when executed by the processor 1604, cause the processor 1604 to perform the operations illustrated in FIG. 13. In certain aspects, computer-readable medium/memory 1612 stores code 1614 for detecting a trigger event indicative of a radio link failure (RLF) on at least one of a first link between a relay UE and a serving network entity or a second link between the remote UE and the relay UE and code 1616 for performing relay reselection, in response to the detection, based on link quality measurements on one or more links between the remote UE and one or more relay UEs and other one or more other criteria. In certain aspects, the processor 1604 has circuitry configured to implement the code stored in the computer-readable medium/memory 1612. The processor 1604 includes circuitry 1622 for detecting a trigger event indicative of a radio link failure (RLF) on at least one of a first link between a relay UE and a serving network entity or a second link between the remote UE and the relay UE and circuitry 1624 for performing relay reselection, in response to the detection, based on link quality measurements on one or more links between the remote UE and one or more relay UEs and other one or more other criteria.

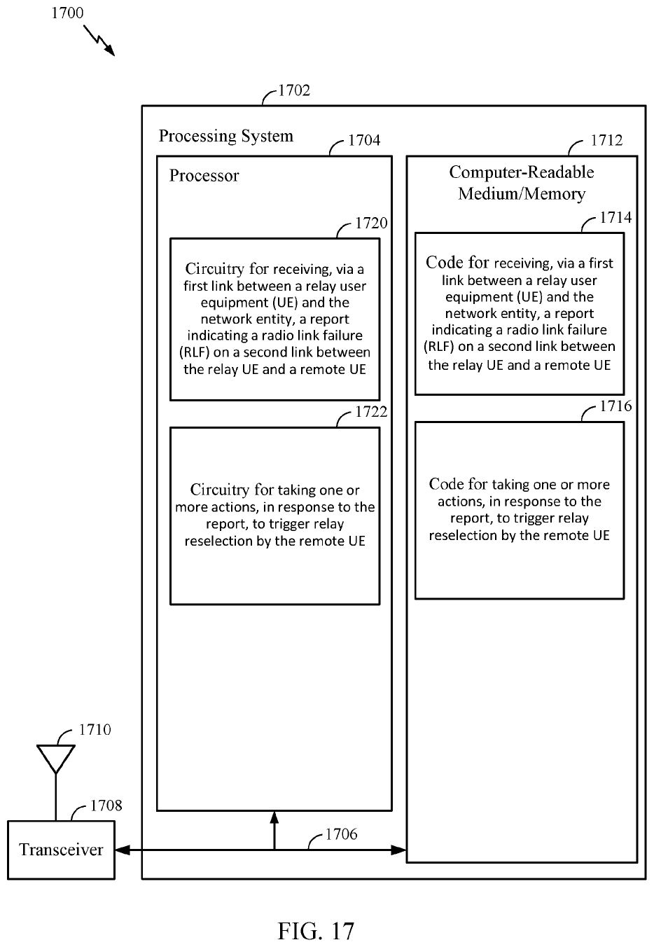

FIG. 17 illustrates a communications device 1700 that may include various components (e.g., corresponding to means-plus-function components) configured to perform operations for the techniques disclosed herein, such as the operations illustrated in FIG. 14. The communications device 1700 includes a processing system 1702 coupled to a transceiver 1708. The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes a processor 1704 coupled to a computer-readable medium/memory 1712 via a bus 1706. In certain aspects, the computer-readable medium/memory 1712 is configured to store instructions (e.g., computer-executable code) that when executed by the processor 1704, cause the processor 1704 to perform the operations illustrated in FIG. 14. In certain aspects, computer-readable medium/memory 1712 stores code 1714 for receiving, via a first link between a relay user equipment (UE) and the network entity, a report indicating a radio link failure (RLF) on a second link between the relay UE and a remote UE and code 1716 for taking one or more actions, in response to the report, to trigger relay reselection by the remote UE. In certain aspects, the processor 1704 has circuitry configured to implement the code stored in the computer-readable medium/memory 1712. The processor 1704 includes circuitry 1722 for receiving, via a first link between a relay user equipment (UE) and the network entity, a report indicating a radio link failure (RLF) on a second link between the relay UE and a remote UE and circuitry 1724 for taking one or more actions, in response to the report, to trigger relay reselection by the remote UE.

### EXAMPLE EMBODIMENTS

Embodiment 1: A method for wireless communications by a relay user equipment (UE), comprising detecting a radio link failure (RLF) on at least one of a first link between the relay UE and a serving network entity or a second link between the relay UE and a remote UE, and taking one or more actions, in response to the detection, to trigger relay reselection by the remote UE.

Embodiment 2: The method of Embodiment 1, wherein the RLF comprises an RLF on at least the first link.

Embodiment 3: The method of Embodiment 2, wherein, if the second link is available, the one or more actions comprise sending a link release message to the remote UE to release the second link, and performing a procedure to reestablish a link with a serving network entity.

Embodiment 4: The method of Embodiment 2 or 3, wherein, if the second link is unavailable, the one or more actions comprise ceasing sending relay discovery messages.

Embodiment 5: The method of any of Embodiments 1-4, wherein the RLF comprises an RLF on at least the second link.

Embodiment 6: The method of Embodiment 5, wherein, if the first link is available, the one or more actions comprise, sending a report indicating the RLF to the network entity.

Embodiment 7: The method of Embodiment 6, wherein the report indicates at least one of an RLF cause, a remote UE ID, or sidelink reference signal received power (SL-RSRP) measurements.

Embodiment 8: The method of Embodiments 6 or 7, wherein the one or more actions further comprise, if the relay UE is in an idle or inactive state, requesting to enter a connected state before sending the report.

Embodiment 9: The method of any of Embodiments 5-8, wherein, if the first link is unavailable, the one or more actions comprise ceasing sending relay discovery messages.

Embodiment 10: A method for wireless communications by a remote user equipment (UE), comprising detecting a trigger event indicative of a radio link failure (RLF) on at least one of a first link between a relay UE and a serving network entity or a second link between the remote UE and the relay UE, and performing relay reselection, in response to the detection, based on link quality measurements on one or more links between the remote UE and one or more relay UEs and other one or more other criteria.

Embodiment 11: The method of Embodiment 10, wherein the trigger event comprises at least one of receipt, from the relay UE, of a link release message for the remote UE to release the second link, or absence of relay discovery messages from the relay UE

Embodiment 12: The method of Embodiment 10 or 11, performing cell selection if the relay reselection fails.

Embodiment 13: The method of Embodiment 12, further comprising declaring an out of coverage state if the cell selection fails.

Embodiment 14: The method of any of Embodiments 10-13, wherein the one or more other criteria involve an access stratum (AS) layer of the remote UE.

Embodiment 15: The method of Embodiment 14, wherein the one or more criteria are based on relay discovery message contents to indicate relay UE candidates to the AS layer, and selection of one or more of the relay UE candidates by the AS layer.

Embodiment 16: The method of Embodiment 15, wherein the relay UE candidates satisfy link quality criteria.

Embodiment 17: The method of any of Embodiments 14-16, wherein the one or more criteria are based on an ordered list of relay UE candidates provided to the AS layer, and selection of one or more of the relay UE candidates by the AS layer based on content of relay discovery messages.

Embodiment 18: The method of Embodiment 17, wherein the relay UE candidates satisfy link quality criteria.

Embodiment 19: The method of any of Embodiments 10-18, wherein the one or more criteria are based on at least one of QoS of relay discovery messages or content of relay discovery messages.

Embodiment 20: A method for wireless communications by a network entity, comprising receiving, via a first link between a relay user equipment (UE) and the network entity, a report indicating a radio link failure (RLF) on a second link between the relay UE and a remote UE, and taking one or more actions, in response to the report, to trigger relay reselection by the remote UE.

Embodiment 21: The method of Embodiment 20, wherein the one or more actions involve a radio resource control (RRC) state management procedure for the Remote UE.

Embodiment 22: The method of Embodiment 21, wherein the RRC state management procedure involves at least one of removing remote UE context or sending the remote UE to an idle state.

Embodiment 23: The method of any of Embodiments 20-22, further comprising, if the relay UE is in an idle or inactive state, receiving a request from the relay UE to enter a connected state before receiving the report.

Embodiment 24: The method of any of Embodiments 20-23, wherein the report indicates at least one of an RLF cause, a remote UE ID, or sidelink reference signal received power (SL-RSRP) measurements.

Embodiment 25: An apparatus for wireless communication by a relay user equipment (UE), comprising a memory and a at least one processor configured to: detect a radio link failure (RLF) on at least one of a first link between the relay UE and a serving network entity or a second link between the relay UE and a remote UE, and taking one or more actions, in response to the detection, to trigger relay reselection by the remote UE.

Embodiment 26: An apparatus for wireless communication by a relay user equipment (UE), comprising means for detecting a radio link failure (RLF) on at least one of a first link between the relay UE and a serving network entity or a second link between the relay UE and a remote UE, and means for taking one or more actions, in response to the detection, to trigger relay reselection by the remote UE

Embodiment 27: An apparatus for wireless communications by a remote user equipment (UE), comprising a memory and a at least one processor configured to detect a trigger event indicative of a radio link failure (RLF) on at least one of a first link between a relay UE and a serving network entity or a second link between the remote UE and the relay UE, and perform relay reselection, in response to the detection, based on link quality measurements on one or more links between the remote UE and one or more relay UEs and other one or more other criteria.

Embodiment 28: An apparatus for wireless communications by a remote user equipment (UE), comprising means for detecting a trigger event indicative of a radio link failure (RLF) on at least one of a first link between a relay UE and a serving network entity or a second link between the remote UE and the relay UE, and means for performing relay reselection, in response to the detection, based on link quality measurements on one or more links between the remote UE and one or more relay UEs and other one or more other criteria.

Embodiment 29: An apparatus for wireless communications by a network entity, comprising a memory and a at least one processor configured to receive, via a first link between a relay user equipment (UE) and the network entity, a report indicating a radio link failure (RLF) on a second link between the relay UE and a remote UE, and take one or more actions, in response to the report, to trigger relay reselection by the remote UE.

Embodiment 30: An apparatus for wireless communications by a network entity, comprising means for receiving, via a first link between a relay user equipment (UE) and the network entity, a report indicating a radio link failure (RLF) on a second link between the relay UE and a remote UE, and means for taking one or more actions, in response to the report, to trigger relay reselection by the remote UE.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 12-14 may be performed by various processors shown in FIG. 4, such as processors 458, 464, 466, and/or controller/processor 480 of the UE 120a, and/or processors 430, 436, 438 and/or the controller/processor 440 of the BS 400.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 12-14.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a relay user equipment (UE), comprising:
detecting a radio link failure (RLF) on at least one of a first link between the relay UE and a serving network entity or a second link between the relay UE and a remote UE; and
taking one or more actions, in response to the detection, to trigger relay reselection by the remote UE.

2. The method of claim 1, wherein the RLF comprises an RLF on at least the first link.

3. The method of claim 2, wherein, if the second link is available, the one or more actions comprise:
sending a link release message to the remote UE to release the second link; and
performing a procedure to reestablish a link with a serving network entity.

4. The method of claim 2, wherein, if the second link is unavailable, the one or more actions comprise:
ceasing sending relay discovery messages.

5. The method of claim 1, wherein the RLF comprises an RLF on at least the second link.

6. The method of claim 5, wherein, if the first link is available, the one or more actions comprise:
sending a report indicating the RLF to the network entity.

7. The method of claim 6, wherein the report indicates at least one of an RLF cause, a remote UE ID, or sidelink reference signal received power (SL-RSRP) measurements.

8. The method of claim 6, wherein the one or more actions further comprise, if the relay UE is in an idle or inactive state, requesting to enter a connected state before sending the report.

9. The method of claim 5, wherein, if the first link is unavailable, the one or more actions comprise:
ceasing sending relay discovery messages.

10. A method for wireless communications by a remote user equipment (UE), comprising:
detecting a trigger event indicative of a radio link failure (RLF) on at least one of a first link between a relay UE and a serving network entity or a second link between the remote UE and the relay UE; and
performing relay reselection, in response to the detection, based on link quality measurements on one or more links between the remote UE and one or more relay UEs and other one or more other criteria.

11. The method of claim 10, wherein the trigger event comprises at least one of:
receipt, from the relay UE, of a link release message for the remote UE to release the second link; or
absence of relay discovery messages from the relay UE.

12. The method of claim 10, further comprising:
performing cell selection if the relay reselection fails.

13. The method of claim 12, further comprising:
declaring an out of coverage state if the cell selection fails.

14. The method of claim 10, wherein the one or more other criteria involve an access stratum (AS) layer of the remote UE.

15. The method of claim 14, wherein the one or more criteria are based on:
relay discovery message contents to indicate relay UE candidates to the AS layer; and
selection of one or more of the relay UE candidates by the AS layer.

16. The method of claim 15, wherein the relay UE candidates satisfy link quality criteria.

17. The method of claim 14, wherein the one or more criteria are based on:
an ordered list of relay UE candidates provided to the AS layer; and
selection of one or more of the relay UE candidates by the AS layer based on content of relay discovery messages.

18. The method of claim 17, wherein the relay UE candidates satisfy link quality criteria.

19. The method of claim 14, wherein the one or more criteria are based on at least one of QoS of relay discovery messages or content of relay discovery messages.

20. A method for wireless communications by a network entity, comprising:
receiving, via a first link between a relay user equipment (UE) and the network entity, a report indicating a radio link failure (RLF) on a second link between the relay UE and a remote UE; and
taking one or more actions, in response to the report, to trigger relay reselection by the remote UE.

21. The method of claim 20, wherein the one or more actions involve a radio resource control (RRC) state management procedure for the Remote UE.

22. The method of claim 21, wherein the RRC state management procedure involves at least one of removing remote UE context or sending the remote UE to an idle state.

23. The method of claim 20, further comprising, if the relay UE is in an idle or inactive state, receiving a request from the relay UE to enter a connected state before receiving the report.

24. The method of claim 20, wherein the report indicates at least one of an RLF cause, a remote UE ID, or sidelink reference signal received power (SL-RSRP) measurements.

25. An apparatus for wireless communication by a relay user equipment (UE), comprising:
a memory and a at least one processor configured to:
detect a radio link failure (RLF) on at least one of a first link between the relay UE and a serving network entity or a second link between the relay UE and a remote UE; and
taking one or more actions, in response to the detection, to trigger relay reselection by the remote UE.

26. An apparatus for wireless communication by a relay user equipment (UE), comprising:
means for detecting a radio link failure (RLF) on at least one of a first link between the relay UE and a serving network entity or a second link between the relay UE and a remote UE; and
means for taking one or more actions, in response to the detection, to trigger relay reselection by the remote UE.

27. An apparatus for wireless communications by a remote user equipment (UE), comprising:
a memory and a at least one processor configured to:
detect a trigger event indicative of a radio link failure (RLF) on at least one of a first link between a relay UE and a serving network entity or a second link between the remote UE and the relay UE; and
perform relay reselection, in response to the detection, based on link quality measurements on one or more links between the remote UE and one or more relay UEs and other one or more other criteria.

28. An apparatus for wireless communications by a remote user equipment (UE), comprising:
means for detecting a trigger event indicative of a radio link failure (RLF) on at least one of a first link between a relay UE and a serving network entity or a second link between the remote UE and the relay UE; and
means for performing relay reselection, in response to the detection, based on link quality measurements on one or more links between the remote UE and one or more relay UEs and other one or more other criteria.

29. An apparatus for wireless communications by a network entity, comprising:
a memory and a at least one processor configured to:
receive, via a first link between a relay user equipment (UE) and the network entity, a report indicating a radio link failure (RLF) on a second link between the relay UE and a remote UE; and
take one or more actions, in response to the report, to trigger relay reselection by the remote UE.

30. An apparatus for wireless communications by a network entity, comprising:
means for receiving, via a first link between a relay user equipment (UE) and the network entity, a report indicating a radio link failure (RLF) on a second link between the relay UE and a remote UE; and
means for taking one or more actions, in response to the report, to trigger relay reselection by the remote UE.
